(19) United States
(12) Patent Application Publication
(10) Pub. No.: US 2016/0035235 A1
(43) Pub. Date: Feb. 4, 2016

(54) SYSTEM AND METHOD THEREOF FOR ENHANCING STUDENTS ENGAGEMENT AND ACCOUNTABILITY

(71) Applicant: ForClass Ltd., Ramat Gam (IL)

(72) Inventors: Gad Allon, Wilmette, IL (US); Ofer Belinsky, Holon (IL); Boaz Shedletsky, Ra'anana (IL)

(73) Assignee: FORCLASS LTD., Ramat Gan (IL)

(21) Appl. No.: 14/815,374

(22) Filed: Jul. 31, 2015

Related U.S. Application Data
(60) Provisional application No. 62/031,866, filed on Aug. 1, 2014.

(51) Int. Cl. G09B 7/00; G09B 7/06; G09B 7/02

(52) U.S. Cl. CPC G09B 7/00; G09B 7/02; G09B 7/06

(57) ABSTRACT

A method and system for enhancing engagement and accountability of students are provided. The method includes posting at least one question to a plurality of user devices associated with the students; receiving, responsive to at least one question, answers from the plurality of user devices; analyzing the received plurality of answers to at least compute statistical information respective of the plurality of answers; displaying the statistical information on a display; receiving a selection of at least a portion of the statistical information; and causing a display of at least one visual representation that includes at least an identifier representative of each user represented in the selection.

### CROSS-REFERENCE TO RELATED APPLICATIONS

This application claims the benefit of U.S. Provisional Application 62/031,866 filed on Aug. 1, 2014, which is herein incorporated by reference for all that it contains.

### TECHNICAL FIELD

The disclosure generally relates to electronic learning (e-learning) systems and more particularly to systems and methods for enhancing students' engagement.

### BACKGROUND

Earning a higher education degree has become an essential step in building a career. In many developed countries, a high proportion of the population now enters higher education at some time in their lives. Higher education is therefore very important to national economies, both as a significant industry in its own right and as a source of trained and educated personnel for the rest of the economy. College educated workers command a significant wage premium and are much less likely to become unemployed than less educated workers.

Students are often expected to learn in exactly the same way even though students are different by nature and usually require customized methods in order to learn new materials. Higher education institutions will employ traditional methods of teaching to all students. Therefore, higher education is not working for every student and students often find themselves lost among large classes of students.

Traditionally the primary means to engage a student is interaction with an instructor. Identifying which students require more engagement, i.e. more interaction with the instructor becomes increasingly difficult as the size of a class grows. Instructors in higher education often employ teaching assistants to help review assignments by hand. Employing teaching assistants further increases the amount of man-hours to identify students in need of engagement, typically at cost to the academic institution. Currently, there is no efficient method of aggregating all the submitted answers to assignments to identify individual students who require increased engagement or topics the class as a whole requires more instruction with.

Furthermore, lack of engagement of students results due to the fact that some students do not have access to the classes that interest them most. Others do not feel challenged, and thus do not engage themselves in classroom discussions are may not be held accountable for the lack of participation. All of these factors result in a major number of drop outs due to a lack of students' engagement.

It would be advantageous to overcome these limitations by providing a solution that increases students' engagement and accountability.

### SUMMARY

A summary of several exemplary embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain exemplary embodiments disclosed herein include a method for enhancing engagement and accountability of students. The method comprises posting at least one question to a plurality of user devices associated with the students; receiving, responsive to at least one question, answers from the plurality of user devices; analyzing the received plurality of answers to at least compute statistical information respective of the plurality of answers; displaying the statistical information on a display; receiving a selection of at least a portion of the statistical information; and causing a display of at least one visual representation that includes at least an identifier representative of each user represented in the selection.

Certain exemplary embodiments disclosed herein include a system for enhancing engagement and accountability of at least one user. The system comprises a processing unit; a memory coupled to the processing unit, memory containing instructions therein that when executed by the processing unit configures the system to: post at least one question to a plurality of user devices associated with the students; receive, responsive to at least one question, answers from the plurality of user devices; analyze the received plurality of answers to at least compute statistical information respective of the plurality of answers; display the statistical information on a display; receive a selection of at least a portion of the statistical information; and cause a display of at least one visual representation that includes at least an identifier representative of each user represented in the selection.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a networked system utilized to describe the various disclosed embodiments.

FIG. 2 is a flowchart describing the operation of a method for generating a visual representation in accordance with one embodiment.

FIG. 3A is a simulation of a display of statistical information according to one embodiment.

FIG. 3B is a simulation of a display of statistical information according to one embodiment.

FIG. 3C is a simulation of a display of statistical information according to one embodiment.

FIG. 4 is a simulation of a visual representation that includes an identifier representative of a student by which an answer was received according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

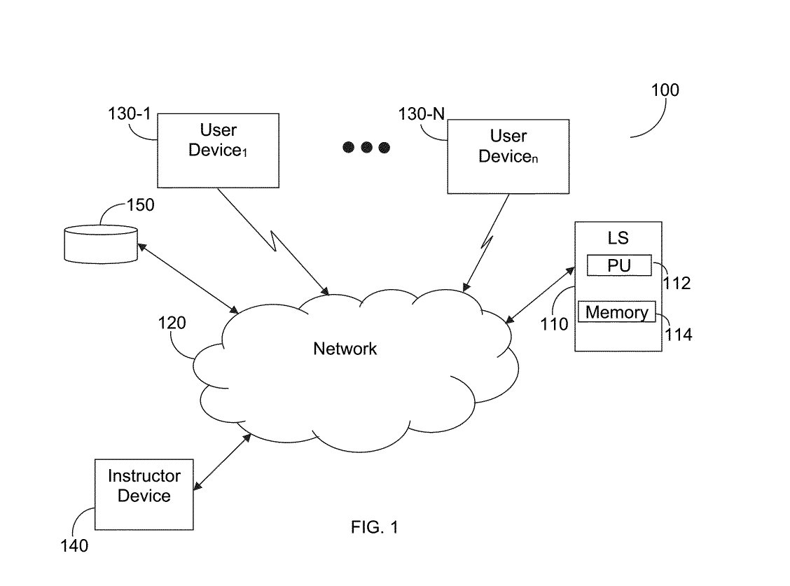

FIG. 1 depicts an exemplary and non-limiting schematic diagram of a networked system 100 utilized to describe the disclosed embodiments.

As shown in FIG. 1, a learning server (LS) 110 is communicatively connected to a network 120. The network 120 can be wired or wireless, a local area network (LAN), a wide area network (WAN), a metro area network (MAN), the Internet, the worldwide web (WWW), the likes, any combinations thereof, and other networks capable of enabling communication between the elements of the system 100.

The system 100 further includes user devices 130-1 through 130-N (collectively referred hereinafter as user devices 130 or individually as a user device 130, merely for simplicity purposes) where N is an integer equal to or greater than 1. The user devices 130 are communicatively connected to the network 120. Each user device 130 is operated by a student (or any user attending a class). The system 100 further comprises at least one instructor device (ID) 140. The instructor device 140 is typically operated by an instructor, such as a teacher, professor, and the like. The instructor device (ID) 140 and a user device 130 and may be, for example, a personal computer (PC), a personal digital assistant (PDA), a mobile phone, a smartphone, a tablet computer, a wearable computing device, and the like.

According to one embodiment, the learning server 110 is configured to receive a plurality of answers from a plurality of students via the plurality of user devices 130 responsive to at least one question. The question(s) may be provided by the learning server 110 or by the instructor device 140. In an embodiment, questions may be selected from a database 150 communicatively connected to the network 120. The database 150 is configured to store academic content. Such academic content may be, but is not limited to, textbooks, lectures, case studies, exams, and the like. In an embodiment, questions sent to the user devices 130 may be retrieved from the academic content in the database 150.

The learning server 110 is configured to generate statistical information respective of one, some, all answers received in response to a posted question. According to an embodiment, the statistical information may include an amount of answers received, a type of each of the answers received, historical data associated with identical answers and/or questions, analysis of terms within the answers, a combination thereof, and the like.

According to a further embodiment, the statistical information may be generated respective of individual students. Statistical information associated with individual students may include, for example, past answers received from individual students, the percentage of correct answers received from individual students, the percentage of questions answered by individual students, a combination thereof, and the like. It should be appreciated that the learning server 110 and the operations of the disclosed embodiments save the instructor a great deal of time by generating the statistical information in a more efficient manner than capable by teaching staff.

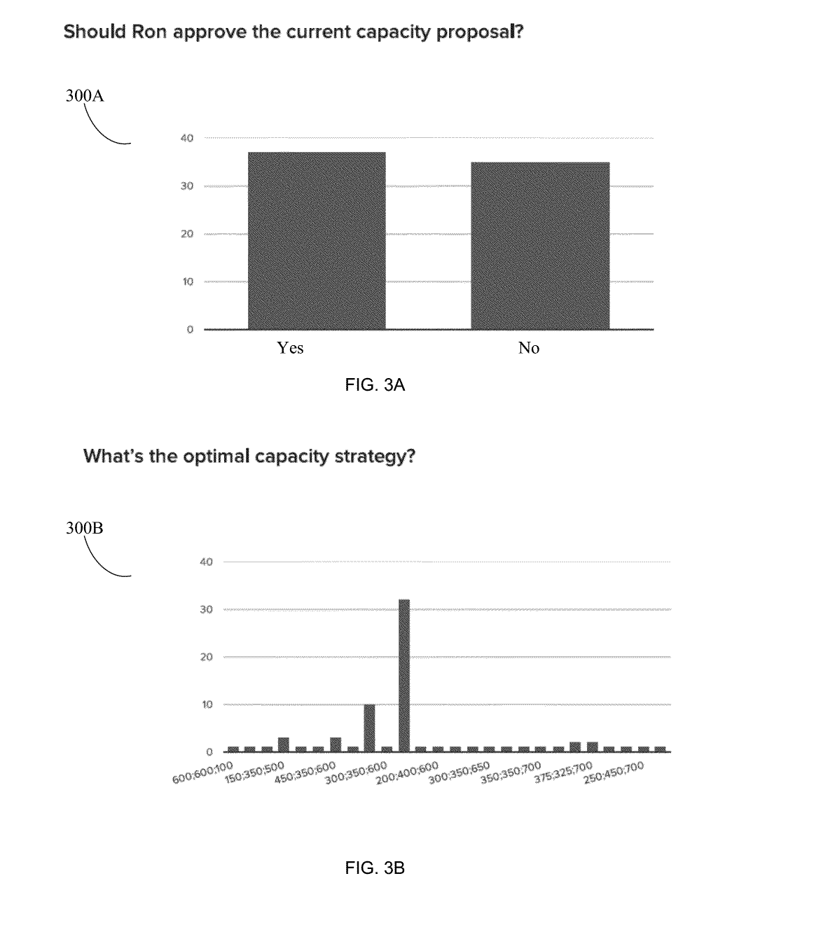

Furthermore, one or more thresholds respective of answers received from students may be preconfigured in the learning server 110. As an example, upon reaching a threshold of wrong answers received by a student via a user device 130 an alert is provided by the learning server 110 to the instructor device 140. The learning server 110 is configured to then display the statistical information generated on, for example, a display unit of the instructor device 140. Exemplary embodiments of a display of statistical information on the instructor device 140 are shown herein below with respect of FIGS. 3A to 3C.

In an embodiment, the statistical information may include an indication of the similarity of answers between user devices 130. Similarities over a certain threshold may indicate plagiarism or cheating. This embodiment is particularly effective when the answers are text.

The learning server 110 is further configured to receive a selection of at least a portion of the statistical information. In an embodiment, the selection may be received from the instructor device 140. In a further embodiment, the selection may be received as a user's gesture or a user query from the instructor device 140. The selection indicates an intent of the instructor of the instructor device 140 to receive additional metadata respective of the selected portion. The selected portion may be a specific set of data within the statistical information. Additional metadata may refer to any type of data associated with any one of the answers, for example, data related to one or more students associated with one or more user devices of the user devices 130 from which an answer was received, past instances related to such student(s), additional statistical information related to an answer, etc., or a combination thereof.

According to another embodiment, the learning server 110 is configured to provide recommendations to the instructor device 140 respective of the type of portion selected. The recommendations may further include at least one topic for discussions with respect of the statistical information and/or the at least one portion thereof. The at least one topic may include, for example, a proposed study plan, a need for tutoring, identification of a common mistake, suggested follow-up lectures and/or questions, a suggestion to discuss an answer in class, identification of plagiarism or cheating, a combination thereof, and the like.

For example, a professor (instructor) using the instructor device 140 may select a portion of answers for one particular homework assignment submitted by one user device 130-1. The learning server 110 is configured to provide additional metadata in response, such as the percentage of correct answers submitted by the user device 130-1 for the same subject material as the homework assignment. The learning server 110 may also provide a recommendation for discussing a study plan with the student using user device 130-1 if the percentage of correct answers submitted is below a certain threshold.

In an embodiment, the learning server 110 is configured to cause a display of at least one visual representation respective of the selection. The visual representations may include at least an identifier representative of a user of each associated user device 130 respective of the selection. The display may be made on a display unit of the instructor device 140. The identifier may be, for example, a name of a user, a picture of a user, demographic information related to a user, past answers received from the user device(s) 130, a combination thereof, and so on. The identifier may be retrieved from the user device 130 or database 150. The visual representation displays the selection in such a manner as to enable the instructor to conduct further analysis of the selection relative to individual users of the user devices 130.

In an embodiment the learning server 110 is installed in a cloud-computing platform, such as a public cloud, a private cloud, or a hybrid cloud. The processes performed by the learning server 110 can be realized by a cloud-based application (as known as SaaS application). It should be noted that the instructor device 140 are the user device 130 are connected to the learning server 110 during a class. This allows the instructor to post questions during the class and receive the answers and the computed statistical information in real-time (during the class) as the students answer the posted question. The statistical information can be displayed by the instructor. This increases the engagement of the interactions of the students with the instructor.

In certain embodiment, the questions can be provided to the user devices 130 by the learning server 110 prior to the class or after the class. The questions (or any other class material) can pushed to the user devices 130 or downloaded to the user devices 130 having the users' access the learning server 110.

In certain configurations, the learning server 110 comprises a processing unit 112 which is coupled to an internal memory 114. The processing unit 112 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

In an embodiment, the memory 114 contains instructions that when executed by the processing unit 112 results in the performance of the methods and processes described herein below. Specifically, the processing unit 112 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 112 to perform the various functions described herein.

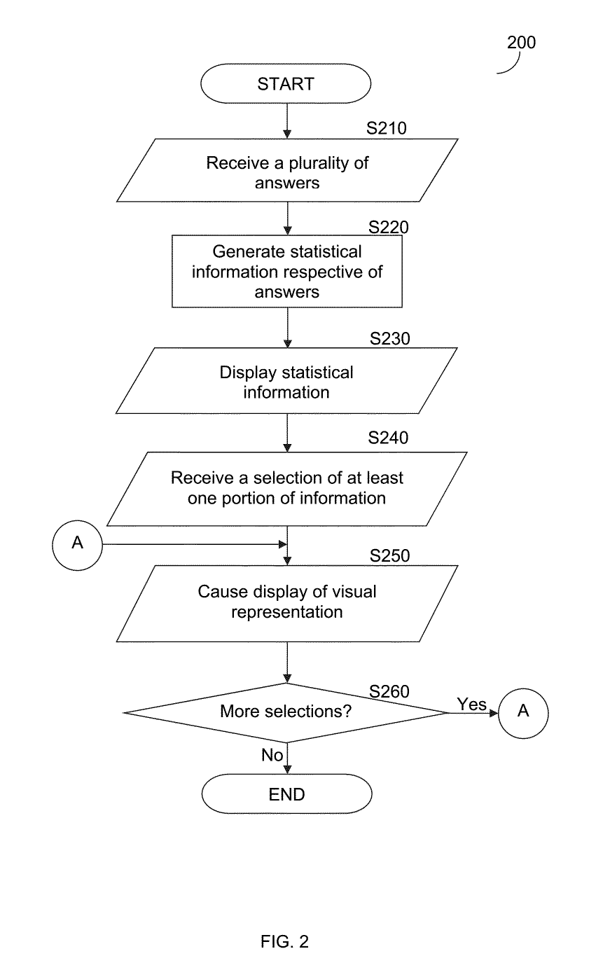

FIG. 2 depicts an exemplary and non-limiting flowchart 200 describing a method for generating a visual representation in accordance with an embodiment. The method may be performed by the learning server 110. Without limiting the scope of the disclosed embodiment, the method will be discussed with reference to the various elements shown in FIG. 1.

In S210, a plurality of answers responsive to at least one question are received from users via their respective user devices 130. In S220, statistical information respective of each of the answers is computed. According to an embodiment, the statistical information may include an amount of answers received, a type of each of the answers received, historical data associated with identical answers and/or questions, analysis of terms within the answers, a combination thereof, and the like.

In an embodiment, the statistical information or measure is computed for each individual student. Examples for such measures include, for example, past answers received from individual students, the percentage of correct answers received from individual students, the percentage of questions answered by individual students, a combination thereof, and the like. It should be noted that the individual computed statistical measures allow tracking of the students' performance over time, compare between students, and so on.

In S230, the statistical information is displayed on the display of the instructor device 140. In S240, a selection of at least a portion of the statistical information is received. In an embodiment, the selection is performed as described herein above.

In S250, at least one visual representation that includes at least one identifier representative of the users is displayed on the display of the instructor device 140. In an embodiment, the at least one visual representation includes data selected in S240. In S260, it is checked whether additional selections are received and if so, execution continues with S250; otherwise, execution terminates.

FIG. 3A shows an exemplary and non-limiting simulation 300A of statistical information respective of yes/no answers as displayed on the instructor device 140. FIG. 3B shows an exemplary and non-limiting simulation 300B of statistical information respective of mathematical answers as displayed on the instructor device 140.

FIG. 3C shows an exemplary and non-limiting simulation 300C of statistical information respective of open text answers as displayed on the instructor device 140. According to this embodiment, the size of each word represents the amount of mentions of that word in answers sent by the user devices 130. The size of the words may indicate the amount of times each word was mentioned generally within all of the answers, or only the mentions made by specified user devices 130. This embodiment of portraying statistical information highlights trends in submitted answers by analyzing the text in such a manner that would be infeasible for an instructor unaided by the system 100.

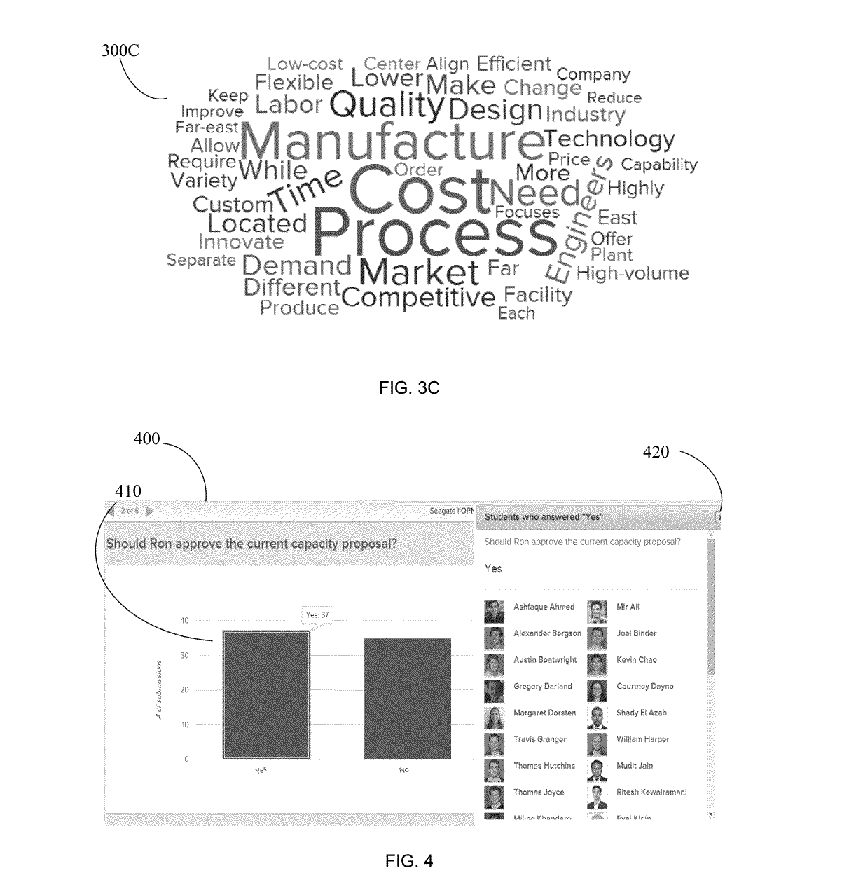

FIG. 4 shows an exemplary and non-limiting simulation of a visual representation 400 with an identifier representative of students from which answer was received according to an embodiment. A selection 410 of the statistical information generated respective of a first answer is received from the instructor device 140. Responsive thereto, a visual representation 420 of images of students associated with the user devices 130 from which the first answer received is display on a display unit of the instructor device 140.

The various embodiments may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal. The display segments and mini-display segments may be shown on a display area that can be a browser or another other appropriate graphical user interface of an internet mobile application, either generic or tailored for the purposes described in detail hereinabove.

All examples and conditional language recited herein are intended for pedagogical purposes to aid the reader in understanding the principles and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for enhancing engagement and accountability of students, comprising:
posting at least one question to a plurality of user devices associated with the students;
receiving, responsive to at least one question, answers from the plurality of user devices;
analyzing the received plurality of answers to at least compute statistical information respective of the plurality of answers;
displaying the statistical information on a display;
receiving a selection of at least a portion of the statistical information; and
causing a display of at least one visual representation that includes at least an identifier representative of each user represented in the selection.

2. The method of claim 1, wherein the statistical information is any one of: an amount of answers received, a type of each of the answers received, historical data associated with identical answers, historical data associated with identical questions, analysis of terms within the plurality of answers, a combination thereof.

3. The method of claim 2, wherein the statistical information is computed for each individual student of the plurality of students.

4. The method of claim 3, wherein the statistical information computed for each individual student includes at least one of: past answers received from the at least one user, the percentage of correct answers received from the at least one user, the percentage of questions answered by the at least one user, a combination thereof.

5. The method of claim 1, wherein the selection indicates an intent of an instructor to receive additional metadata respective of the selected at least a portion of the statistical information.

6. The method of claim 5, wherein the additional metadata comprises any one of: data related the user associated the user device from which an answer was received, past instances related to the user, additional statistical information related to the answer, a combination thereof.

7. The method of claim 6, further comprising:
providing a recommendation respective of the selection, wherein the recommendation comprises at least one topic for discussion with respect to the statistical information.

8. The method of claim 8, wherein the at least one topic includes at least one of: a proposed study plan, a need for tutoring, identification of a common mistake, at least one suggested follow-up lecture, at least one suggested follow-up question, a suggestion to discuss an answer in class, a combination thereof.

9. The method of claim 1, wherein the at least one question is pushed to the plurality of the user devices during a class, and wherein the answers are received and analyzed in real-time.

10. A non-transitory computer readable medium having stored thereon instructions for causing one or more processing units to execute the method according to claim 1.

11. A system for enhancing engagement and accountability of at least one user, the system comprising:
a processing unit;
a memory coupled to the processing unit, memory containing instructions therein that when executed by the processing unit configures the system to:
post at least one question to a plurality of user devices associated with the students;
receive, responsive to at least one question, answers from the plurality of user devices;
analyze the received plurality of answers to at least compute statistical information respective of the plurality of answers;
display the statistical information on a display;
receive a selection of at least a portion of the statistical information; and
cause a display of at least one visual representation that includes at least an identifier representative of each user represented in the selection.

12. The system of claim 11, wherein the statistical information is any one of: an amount of answers received, a type of each of the answers received, historical data associated with identical answers, historical data associated with identical questions, analysis of terms within the plurality of answers, a combination thereof.

13. The system of claim 12, wherein the statistical information is computed for each individual student of the plurality of students.

14. The system of claim 13, wherein the statistical information computed for each individual student includes at least one of: past answers received from the at least one user, the percentage of correct answers received from the at least one user, the percentage of questions answered by the at least one user, a combination thereof.

15. The system of claim 11, wherein the selection indicates an intent of an instructor to receive additional metadata respective of the selected at least a portion of the statistical information.

16. The system of claim 15, wherein the additional metadata comprises any one of: data related the user associated the user device from which an answer was received, past instances related to the user, additional statistical information related to the answer, a combination thereof.

17. The system of claim 16, wherein the system further configured to:
provide a recommendation respective of the selection, wherein the recommendation comprises at least one topic for discussion with respect to the statistical information.

18. The system of claim 18, wherein the at least one topic includes at least one of: a proposed study plan, a need for tutoring, identification of a common mistake, at least one suggested follow-up lecture, at least one suggested follow-up question, a suggestion to discuss an answer in class, a combination thereof.

19. The system of claim 11, wherein the at least one question is pushed to the plurality of the user devices during a class, and wherein the answers are received and analyzed in real-time.
